(19) United States
(12) Patent Application Publication
(10) Pub. No.: US 2005/0236235 A1
(43) Pub. Date: Oct. 27, 2005

(54) Wheel-braking structure

(76) Inventor: Deng-Hsi Chen, Keelung (TW)

Correspondence Address: RABIN & BERDO, P.C., Suite 500, 1101 14th Street, N.W., Washington, DC, 20005, US

(21) Appl. No.: 10/829,446

(22) Filed: Apr. 22, 2004

(51) Int. Cl. B60T 1/00

(52) U.S. Cl. 188/31; 188/21

(57) ABSTRACT

A wheel-braking structure comprising a wheel body, a switch top-board and a braking block such that the switch top-board stops the braking block screw-fixed on wheel central shaft and thus brakes the wheels on both sides; wherein the switch top-board is mounted at a proper location on wheel body and has a hole on top such that braking block is screw-fixed on the central shaft of the wheel body, the movement of switch top-board causes the hole to move forward and backward; when the hole is aligned with braking block, wheels can move freely; when they are not aligned, the braking block is stopped by switch top-board and sets it in a lockup state. This not only facilitates operation but also achieves effective braking.

### BACKGROUND OF THE INVENTION

I. Field of the Invention

The present invention relates generally to a wheel-braking structure and, more specifically, to a structure that comprises a wheel body, a braking block and a switch top-board; wherein the switch top-board stops the braking block screw-fixed on wheel central shaft and thus brakes the wheels on both sides.

II. Description of the Prior Art

Heretofore, it is known that wheels are equipped at the bottom of objects to facilitate movement or objects are directly placed on carts with wheel structures to save efforts. However, when used on slope or when it is necessary to stop at a certain location, such wheel structure should have a braking structure.

In the wheel structure (a) of conventional handcarts and rickshaws, braking structure (b) is usually mounted on steering wheels; wherein the two steering wheels are mounted on both lower sides in the front and usually have braking structure (b) which is usually coupled with wheel axis (a1) or wheel face (a2) via a braking block (b1) such that it stops the rotation of wheel structure (a) and achieves the purpose of braking. When in use, it is necessary to operate the braking structure (b) of both steering wheels (a1) or the vehicle may produce unidirectional rotation and thus cannot be braked. In addition, the above mechanism not only results in high cost but also causes damage to wheel structure (a). Therefore, it needs improvement.

To address the above disadvantages, the present invention provides a simple operating mechanism, which can achieve effective braking and reduce production cost without causing wear to the wheel structure.

### SUMMARY OF THE INVENTION

The primary objective of the present invention is to provide a braking structure for wheel structures, which not only facilitates operation but also effectively stops the rotation of the wheels, thus achieving braking effect.

In order to achieve the objective set forth, the wheel-braking structure in the present invention comprises a wheel body, a switch top-board and a braking block; wherein, the wheel body comprises a frame body, a central shaft that passes through the center of frame body, and wheels located on both ends; when switch top-board passes through the opening in the middle section of frame body, it locks a top-board in front of the switch top-board; a square hole is made at a proper location on the switch top-board; the square hole is larger than the braking block in size; the braking block is in rectangular shape screw-fixed in the center of the central shaft.

Based on the structure described above, when the switch top-board moves forward and backward, the square hole moves forward and backward accordingly; when switch top-board moves forward, square hole also moves forward, making the square hole aligned with braking block, such that wheel can rotate freely. On the other hand, when the switch top-board pushes backward, it makes one side of rectangular braking block attach to switch top-board and achieves a lockup state. The structure is applicable to the wheel structures of handcarts and rickshaws of various types. It not only facilitates operation but also effectively stops the rotation of wheel structures, thus achieving braking effect. In addition, this structure can reduce the number of braking components, minimize production cost, reduce assembling time and simplify assembling procedures.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of prior art;

FIG. 2 is an assembly view of the present invention;

FIG. 3 is a perspective view of the present invention;

FIG. 4A is an application view (1) of a further embodiment of the present invention;

FIG. 4B is another application view (2) of a further embodiment of the present invention.

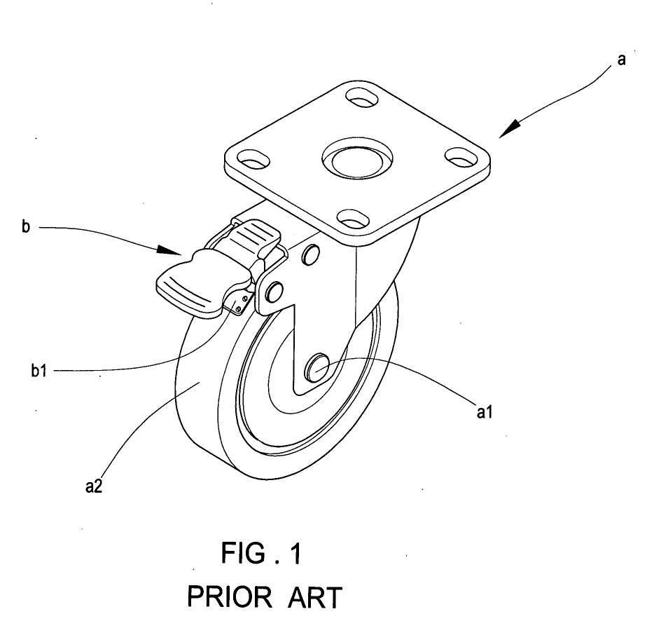

### DESCRIPTION OF THE PREFERRED EMBODIMENT

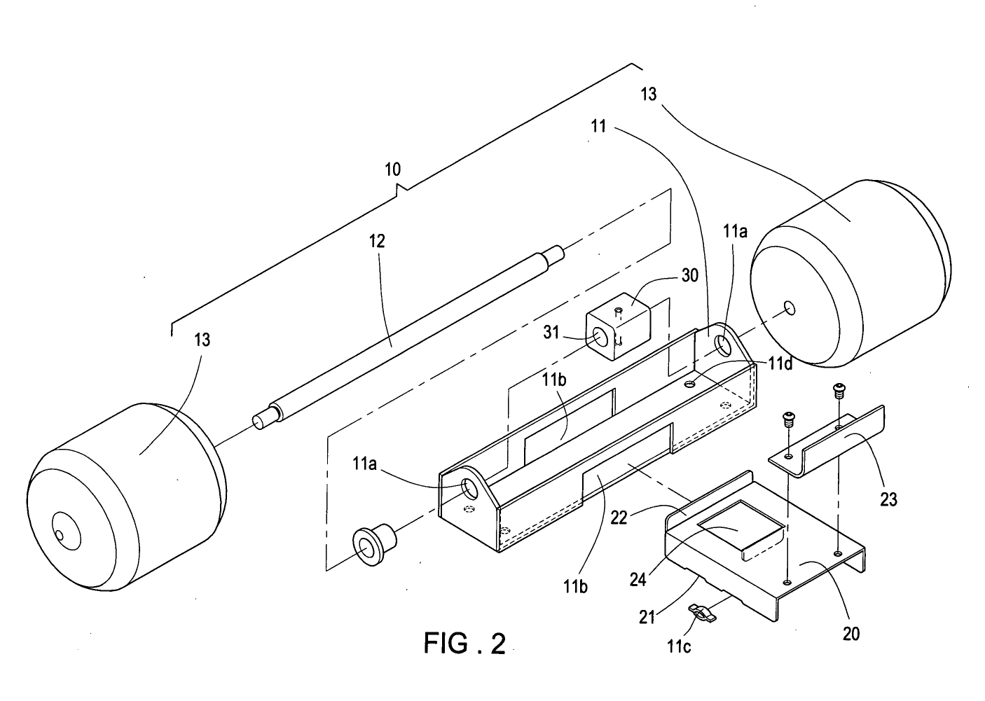

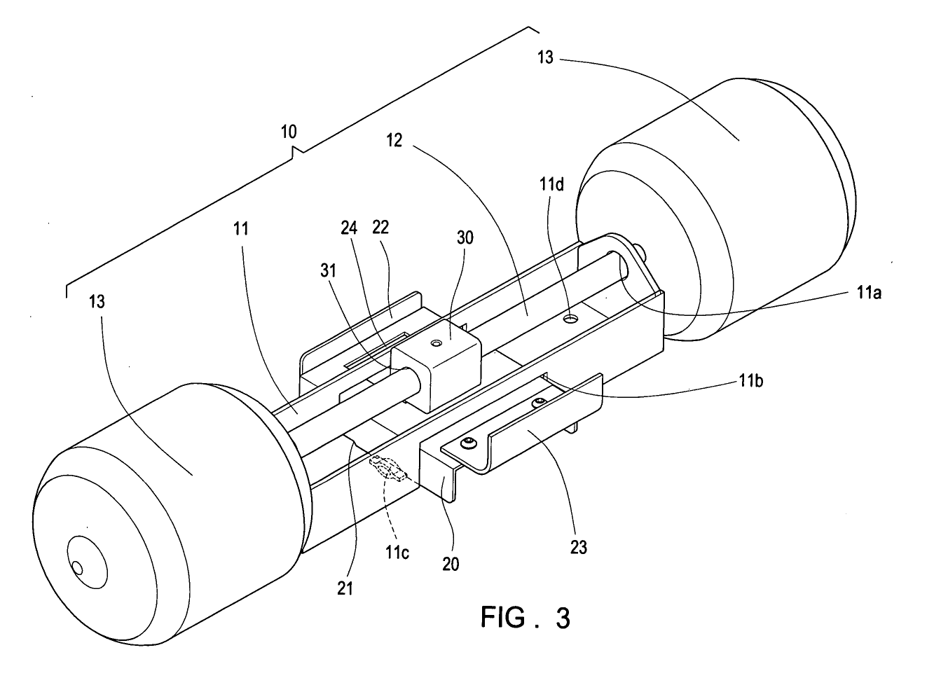

Referring to FIG. 2 and FIG. 3, the present invention comprises a wheel body 10, a switch top-board 20 and a braking block 30. The function of each component is described as following:

The wheel body 10 comprises a frame body 11, a wheel central shaft 12 and a pair of wheels 13. The frame body 11 is a metal plate bent downward on four sides into a rectangular box; two round holes 11a are on the two shorter sides which the wheel central shaft 12 can pass. The wheels 13 are mounted on both ends of the wheel central shaft 12; in addition, an opening 11b is made in the middle section of the front and back sides of the frame body 11 near the top edge; a metal spring sheet 11c is mounted in the opening 11b near the top inner side; on the top of the frame body 11 are a plurality of screw holes 11d for fixing purposes.

The switch top-board 20 is a metal plate bent on both sides into inverted “U” shape and with serrated structure 21 along the edge, wherein metal spring sheet 11c is clamped in the serrated structure 21 to stabilize the upward and downward movement caused by the forward and backward movement of the switch top-board 20; the edge of the serrated structure 21 is bent downward into a foldable board 22 which can be inserted into the opening 11b in the middle section of the frame body 11 and locks a top-board 23 in front of the switch top-board 20, making switch top-board 20 moveable without falling off the frame body 11. Moreover, a square hole 24 is made at proper location on the switch top-board 20 and the square hole 24 is larger than braking block 30 in size.

The braking block 30 is a rectangular block with a through hole 31 passing through both sides; the central shaft 12 of the wheel body 10 passes through the hole 31 and is fixed by screws.

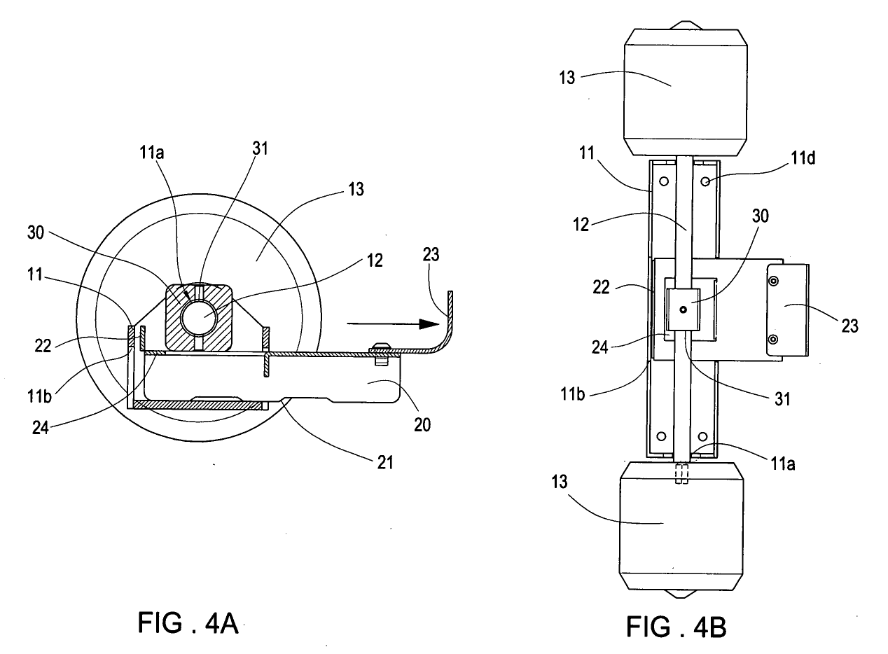

FIG. 4A and FIG. 4B show the operation of the wheels 13 and the switch top-board 20 in the present invention, wherein when the switch top-board 20 moves forward and backward, the square hole 24 moves forward and backward accordingly. When the switch top-board 20 moves forward, the square hole 24 also moves forward, making the square hole 24 aligned with the braking block 30, such that the wheels 13 can rotate freely; on the other hand, when the switch top-board 20 pushes backward, one side of the angular braking block 30 attaches to the switch top-board 20 and achieves a lockup state.

Based on above description, by using the interaction between the switch top-board and the braking block, the present invention not also improves convenience for operation but also effectively stops the rotation of wheels, thus achieving braking effect. In addition, this structure can reduce production cost, minimize assembling time and simplify assembly procedures, representing a practical and leading technology.

While a preferred embodiment of the invention has been shown and described in detail, it will be readily understood and appreciated that numerous omissions, changes and additions may be made without departing from the spirit and scope of the invention.

1. A wheel-braking structure comprising:
a wheel body, a switch top-board and a braking block; wherein, said wheel body comprises a frame body, a central shaft that passes through the center of said frame body, and wheels located on both ends, said switch top-board passes through the opening in the middle section of said frame body and locks a top-board in front of said switch top-board, a square hole is made at a proper location on said switch top-board, said square hole is larger than said braking block in size, said braking block is in rectangular shape and screw-fixed in the center of said central shaft on said wheel body such that when said switch top-board moves, said switch top-board enables said braking block to attach to said switch top-board and thus achieves braking effect.

2. The wheel-braking structure of claim 1, wherein said frame body is a metal plate bent downward on four sides into a rectangular box, two round holes are on two shorter sides which said wheel central shaft can pass, wheels are mounted on both ends of the said wheel central shaft, an opening is made in the middle section of the front and back sides of said frame body near the top edge.

3. The wheel-braking structure of claim 1, wherein said switch top-board is a metal plate bent on both sides into inverted “U” shape and with serrated structure along the edge, the rear edge is bent downward into a foldable board which can be inserted into said opening in the middle section of said frame body and locks a top-board in front of said switch top-board, making said switch top-board moveable without falling off said frame body, a square hole is made at proper location on said switch top-board, said square hole is larger than said braking block in size.

4. The wheel-braking structure of claim 2, wherein a metal spring sheet is mounted in the inner side of said opening on said frame body, said metal spring sheet is clamped in said serrated structure to stabilize the upward and downward movement caused by the forward and backward movement of said switch top-board.

5. The wheel-braking structure of claim 2, wherein a plurality of screw holes are on the top of said frame body for fixing purposes.

6. The wheel-braking structure of claim 2, wherein said braking block is a rectangular block with a through hole on one side, said central shaft of said wheel body passes through said through hole and is fixed by screws.
